(19) United States
(12) Patent Application Publication
(10) Pub. No.: US 2017/0147543 A1
(43) Pub. Date: May 25, 2017

(54) ENABLING LEGACY WEB APPLICATIONS FOR MOBILE DEVICES

(71) Applicant: International Business Machines Corporation, Armonk, NY (US)

(72) Inventors: Idan Ben-Harrush, Givat Elah (IL); Nili Guy, Haifa (IL); Gal Shachor, Yokneam (IL)

(21) Appl. No.: 14/951,984

(22) Filed: Nov. 25, 2015

(51) Int. Cl. G06F 17/22

(52) U.S. Cl. CPC G06F 17/2288; G06F 17/2247; G06F 17/2205

(57) ABSTRACT

Displaying Web 1.0 application content on a mobile computing device includes one or more processors request website content, based on a URL corresponding to the website. The web page is generated and includes dynamic content and references to static resources. The web page is crawled and the static resources of the web page are identified. The identified static resources of the web page are compared to the static resources stored on the mobile computing device. In response to determining the absence of a static resource of the web page stored on the mobile computing device, the absent static resource is downloaded and stored within the mobile computing device. In response to accessing the web page of the website, the web page is generated by the dynamic content from the web server and the static content stored on the mobile computing device.

### FIELD OF THE INVENTION

The present invention relates generally to the field of mobile computing device applications, and more particularly to facilitating responsiveness of Web 1.0 applications for mobile computing devices.

### BACKGROUND OF THE INVENTION

Applications associated with Web 1.0 are characterized as having web pages that are generated on the web server, instead of a web application written in a dynamic programming language. Many Web 1.0 applications include JavaServer Pages (JSP) that include separate dynamic and static HTML components of a webpage, in which the webpage is generated by the server on which the dynamic components are accessible, and the static components are stored.

Creating a mobile application based on a Web 1.0 application is challenging, as the webpage hosting server must generate the web content, preventing the bundling of all resources of the existing web application as a mobile hybrid client application. In some cases, an entire rewrite of the application is performed to enable the application as a mobile application, which if avoidable, is preferred. Other approaches to modify the Web 1.0 application for mobile computing device use, are often accompanied by performance or user-experience issues.

### SUMMARY

Embodiments of the present invention disclose a method, computer program product, and system for displaying web content on a mobile computing device. The method for displaying web content on a mobile computing device provides for one or more processors to request web content from a website, based on a uniform resource locator that corresponds to the website. One or more processors receive the web content from the website, which includes dynamic content and one or more references to one or more static resources, respectively, in which the one or more static resources are static content. One or more processors determine the one or more static resources referenced in the web content. One or more processors determine whether the one or more static resources referenced in the web content are stored on the mobile computing device. In response to determining that a first static resource of the one or more static resources referenced in the web content is not stored within the mobile computing device, one or more processors download the first static resource of the one or more static resources referenced in the web content, and store the first static resource within the mobile computing device, and one or more processors build the web content on the mobile computing device by using the first static resource stored on the mobile computing device.

### BRIEF DESCRIPTION OF THE SEVERAL VIEWS OF THE DRAWINGS

FIG. 1 is a functional block diagram illustrating a distributed data processing environment, in accordance with an embodiment of the present invention.

FIG. 2 is a block diagram illustrating exemplary enabling components of a mobile device, in accordance with an embodiment of the present invention.

FIG. 3 illustrates operational steps of a web content program, inserted on a mobile computing device within the distributed data processing environment of FIG. 1, in accordance with an embodiment of the present invention.

FIG. 4 depicts a block diagram of some components of a mobile computing device capable of operationally performing the web content program, in accordance with an embodiment of the present invention.

### DETAILED DESCRIPTION

Embodiments of the present invention recognize that some legacy web applications, operating on web servers, include JavaServer Page (JSP) technology, which generates web pages based on HTML, XML, and/or other document types. JSPs often include dynamic content, which may be content retrieved from a file or database, and static content, which is often stored on the web server. When a computing device accesses a website on the web server, the legacy web application, often referred to as a Web 1.0 application, generates a web page dynamically, building the web page from dynamic elements accessed from files or databases, for example, and static content stored on the web server. Dynamically generating the web page by the web server creates a challenge when applications of this type are considered for use by mobile devices. The access of dynamic content in files or a database, as well as the retrieval of static content on the web server, followed by the dynamic build and delivery of the web page, creates a performance issue for most mobile devices. In general, applications that do not perform well, are not used. Re-writing or modifying applications for mobile device use is time consuming and expensive, and some clients do not have access to the source code for legacy applications written some time ago.

Embodiments of the present invention provide a method, computer program product, and computer system for displaying web content on a mobile computing device. Some embodiments of the present invention include a mobile computer device application that analyzes a web page requested from a website operating a legacy web application, and determines on the fly, the static content of the web page. Some embodiments further determine whether the static content is stored locally, and if not found in local storage, asynchronously downloads (one time) the static content that is not found in local storage, from the web server. The downloaded static content is stored in a “container” on the mobile computing device that is configured to be associated with the website of the web server. Upon a subsequent request to access the web page, embodiments of the present invention intervene to complete the build of the web page by use of the static content stored locally within the container on the mobile computing device; loading the accessed web page more efficiently and enabling additional features of the mobile computing device to remain active and available.

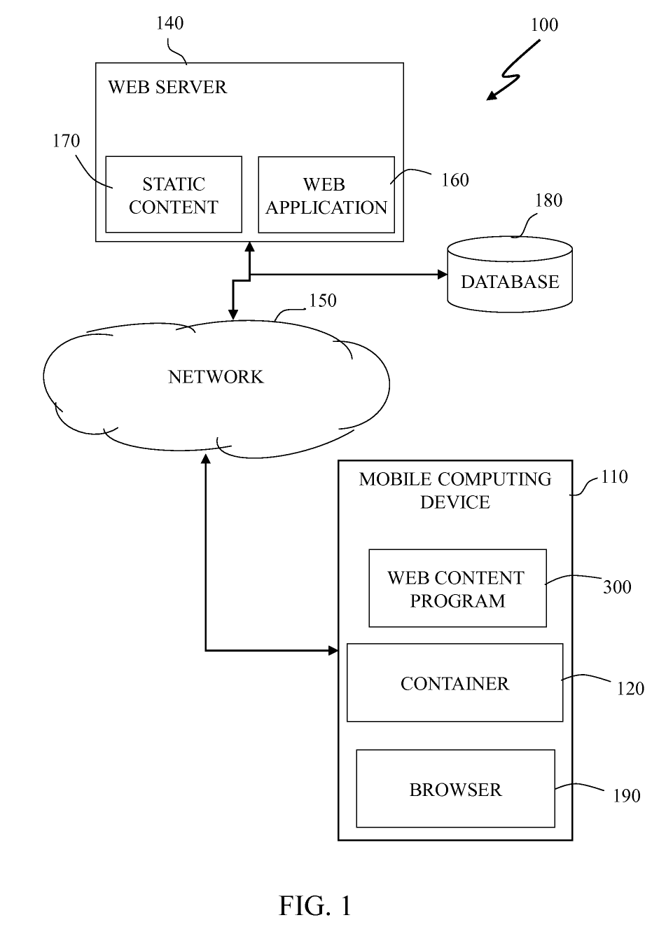

The present invention will now be described in detail with reference to the Figures. FIG. 1 is a functional block diagram illustrating a distributed data processing environment, generally designated 100, in accordance with an embodiment of the present invention. Distributed data processing environment 100 includes mobile computing device 110, which is shown as including web content program 300, container 120, and browser 190. Distributed data processing environment also includes database 180, and web server 140, shown hosting web application 160, and static content 170. Web server 140, database 180, and mobile computing device 110 are all connected via network 150.

Network 150 can be, for example, a local area network (LAN), a telecommunications network, a wide area network (WAN), such as the Internet, a virtual local area network (VLAN), or any combination that can include wired, wireless, or optical connections. In general, network 150 can be any combination of connections and protocols that will support communications between the applications and components of web server 140, database 180, and the applications and components of mobile computing device 110, in accordance with embodiments of the present invention.

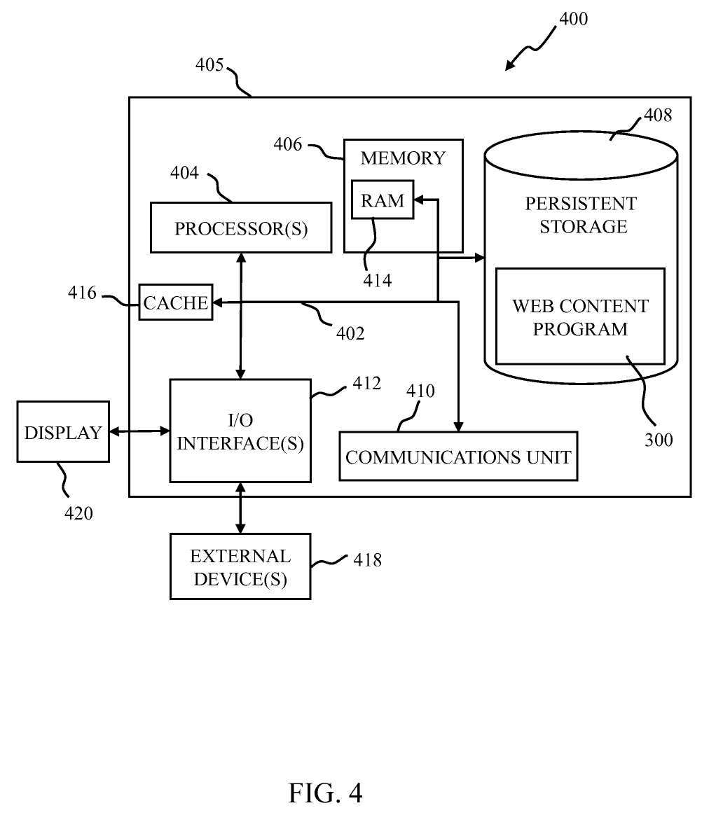

Web server 140 is a computing device remote to mobile computing device 110. Web server 140 includes web application 160, and static content 170. In some embodiments of the present invention, web server 140 generates web pages in response to requests to access a website operated by web application 160. In some embodiments of the present invention web server 140 may be a management server, a web application server, a blade server, a mobile computing device, or other electronic device or computing system capable of receiving and sending data. In other embodiments, web server 140 may represent a virtual computing device of a computing system utilizing multiple computers as a server system, such as in a cloud computing environment. In another embodiment, web server 140 may be a laptop computer, a tablet computer, a netbook computer, a personal computer (PC), a desktop computer, a personal digital assistant (PDA), or any programmable electronic device capable of access to network 150, and performing the operational steps of web application 160. In another embodiment, web server 140 represents a computing system utilizing clustered computers and components (e.g., database server computers, application server computers, etc.) that act as a single pool of seamless resources when accessed within distributed data processing environment 100. Web server 140 may include internal and external hardware components, as depicted and described with reference to FIG. 4.

Web application 160 is a Web 1.0 application that includes JSPs, which support a website on web server 140, which may be referred to as a web application server. Web application 160 is accessed by providing the uniform resource identifier (URI) that corresponds to the website supported by web application 160, to web content program 300, a web application included on mobile computing device 110. A URI can be further classified as a locator, a name, or both. The term Uniform Resource Locator (URL) is a type of URI, and refers to the subset of URIs that, in addition to identifying a resource, provide a means of locating the resource by its network location. For simplicity and consistency, references to accessing or receiving content from a website will refer to a URL, with the understanding that a URL both identifies and locates the website, and thus the URL corresponds to the website.

When accessed by a URL link, web application 160 generates a web page associated with the particular URL that corresponds to the website, by processing JSPs, which include references to static content stored on web server 140, and dynamic content. In some embodiments of the present invention, dynamic content used by web application 160 to generate a web page may reside in files stored on web server 140, may be accessed from a database, such as database 180, or may be accessed from other sources which are connected to network 150 (not shown). Web application 160 dynamically generates the web page associated with a particular URL link when the URL is accessed by another computing device, such as mobile computing device 110, and builds the web page each time the URL is accessed, by retrieving and combining dynamic and static content.

Static content 170 includes the web page “static resources” that remain constant through multiple builds and displays for multiple users of a web page associated with a particular website. Static content 170 may include for example, but are not limited to, cascading style sheets (CSS), formatting content, hypertext markup language (HTML) files, JavaScript, and images. Although static content 170 may be updated, it is characterized by not varying based on the user or entity accessing the web page, or the frequency of accessing the web page, of the website.

Database 180 is a source of data that is used by web application 160 to provide dynamic content to a web page generated by web application 160 on web server 140. Database 180 may include, for example, profile or settings data for individual users that access the website supported by web application 160. The profile or settings data may provide user-specific information, such as name, account number, and status, or may display user preferences, such as language. In some embodiments of the present invention, dynamic content may be accessed from files, tables, or other storage structures, accessible to a web application, such as web application 160.

Mobile computing device 110 is a computing device that includes web content program 300, container 120 and browser 190. In some embodiments of the present invention, mobile computing device 110 may be any mobile electronic device or mobile computing system capable of receiving and sending data. In other embodiments, mobile computing device 110 may represent a virtual instance of a computing device generated from a computing system utilizing multiple computers as a server system, such as in a mobile device connected to a cloud computing environment. In another embodiment, mobile computing device 110 may be a laptop computer, a tablet computer, a netbook computer, a personal computer (PC), a personal digital assistant (PDA), a smart phone, or any mobile programmable electronic device capable of performing the operational steps of web content program 300, via network 150. In another embodiment, mobile computing device 110 represents a computing system utilizing clustered computers and components (e.g., database server computers, application server computers, etc.) that act as a single pool of seamless resources when accessed within distributed data processing environment 100. Mobile computing device 110 may include internal and external hardware components, as depicted and described with reference to FIG. 4.

Browser 190 is an application included in mobile computing device 110 that enables access to and viewing of content from websites on the World Wide Web, using access to the Internet via network 150. Browser 190 typically receives a URL from input or selection of a link and accesses and displays content associated the URL.

Container 120 is a storage structure within mobile computing device 110. In some embodiments of the present invention, container 120 may be a programmed-based storage structure, and in other embodiments, container 120 may be a tangible storage component of mobile computing device 110. In yet other embodiments, container 120 is a combination of a storage structure and programmable instructions, such as those of web content program 300, bundled together on mobile computing device 110 as an application, also referred to as an “app”. Container 120 is associated with a particular website supported by a web application, such as web application 160, the particular association is accomplished by a configuration of container 120. In some embodiments of the present invention, container 120 includes the one-time downloaded static content, sometimes referred to as static resources, associated with one or more web pages of a website supported by a web application. For example, static content 170, downloaded once and stored locally in container 120 of mobile computing device 110, and used to build web pages associated with the website that web application 160 supports. Container 120 may include a set of static content for multiple web pages associated with the particular website supported by web application 160; however, a set of static content for a second website is included in a separate container (not shown) within the storage capabilities of mobile computing device 110. In some embodiments of the present invention, container 120 may be a partitioned part of memory of mobile computing device 110. In other embodiments, container 120 may be all or part of a solid-state memory component included, attached, or connected to mobile computing device 110.

Web content program 300 is an application locally operating on mobile computing device 110. In some embodiments of the present invention, web content program 300 accesses a website via browser 190, and modifies the build and display of web pages that are dynamically generated from a Web 1.0 JSP web application of the website. Web content program 300 is initiated as an application operating on mobile computing device 110, and is configured with a particular URL to accesses a particular website, for example, the website supported by web application 160. Web content program 300 analyzes the web page generated by web application 160 and determines whether the static content, such as static content 170, hereafter referred to as “static resources”, are included in container 120 of mobile computing device 110. Determining that the static resources are included in container 120, web content program 300 intervenes in the build of the web page, and includes the static resources sourced locally from container 120 on mobile computing device 110, along with the dynamic content from web application 160, to build the web page, which is displayed on mobile computing device 110. The efficiency and performance of the build and display of the web page is improved by the separation and use of locally stored static resources, as opposed to a slower and less efficient retrieval of multiple static resources from one or more remote sources. Web content program 300 crawls the web page that is accessed and determines the particular set of static resources (static content) for that particular web page of a particular website. If the static content is not previously stored in container 120, as determined by web content program 300, web content program 300 downloads the static content, asynchronously, to container 120, such that the next access of the web page will result in the use of the static resources stored locally in container 120 which, for example, is configured to be particularly associated with web pages of the website supported by web application 160.

Web content program 300 also determines, during crawling and analysis of the dynamic and static content of the accessed web page, whether a static resource is new, or has changed as compared to the stored static resources in container 120. For example, web content program 300 determines whether a first image has been replaced with a second image, or if the contents of an HTML text document have been edited. If web content program 300 determines that static resources have changed or have been edited, the newer version is downloaded to container 120 and replaces or supersedes previous versions. Additionally, web content program 300 determines if third party packages are used by the web page that is accessed. The third party packages, sometimes referred to as “common packages” are used by many web pages and are re-usable resources that provide web page attributes that are commonly used. In some embodiments of the present invention, third party packages may be downloaded and stored within the container of the mobile computing device, and subsequently used for multiple web pages, without requiring additional downloads. In other embodiments, the most common third party packages may be pre-downloaded and avoid initial download time during the first access of the web page.

Operating in this manner, web content program 300, intervenes to only load the dynamic content of the web page from the web server 140, remotely located, while integrating the static resources directly from container 120, which are stored locally and associated particularly with the website supported by web application 160. Web content program 300 does not require pre-processing of the existing web application 160, and for access, applies the URL of the existing website, such as the website URL of web application 160.

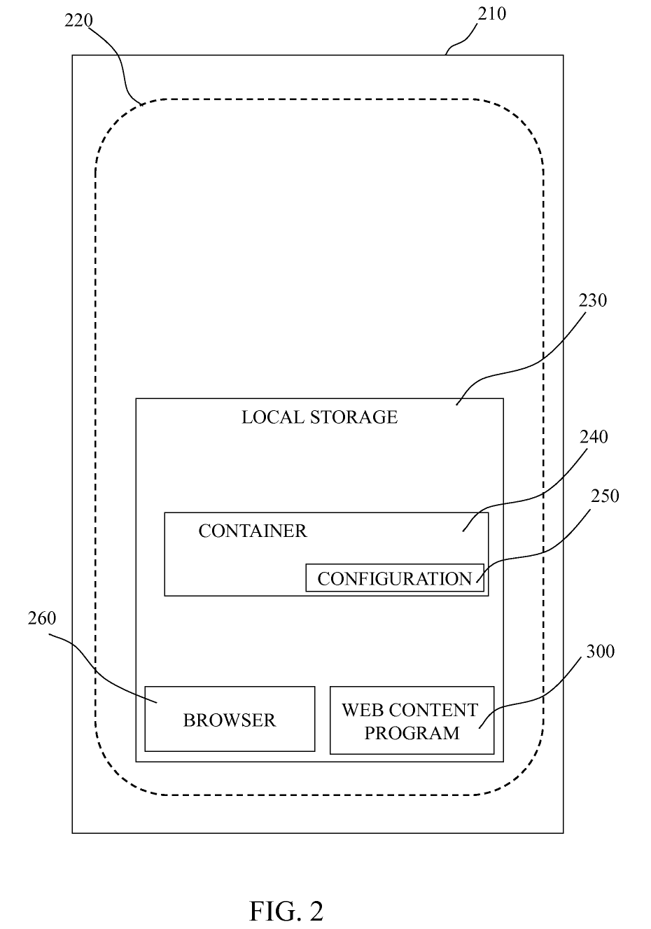

FIG. 2 is a block diagram illustrating an example of enabling components of mobile computing device 210, in accordance with an embodiment of the present invention. FIG. 2 includes mobile computing device 210, display 220, and local storage 230, which includes browser 260, web content program 300, and container 240 with corresponding configuration 250. In some embodiments of the present invention, mobile computing device 210, which has similar functions and components as mobile computing device 110, may be a tablet, a personal digital assistant (PDA) device, a smart phone, or any other mobile computing device that may have operating systems particular for a mobile computing device, and may have limitations on processing power and memory. Mobile computing device 210 includes display 220, which is a screen on which applications display content, such as browser 260 displaying web pages accessed from websites. Mobile computing device 210 may include telephonic components and software, as well as other features, such as a camera (not shown), and may include internal and external hardware components, as depicted and described with reference to FIG. 4.

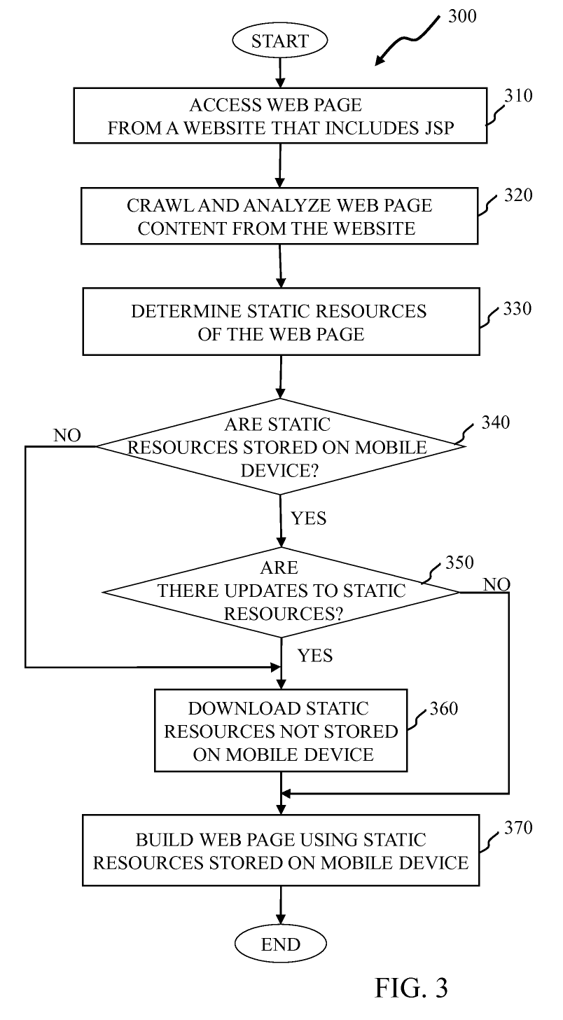

Local storage 230 represents storage memory of mobile computing device 210, and includes container 240 and storage of browser 260, as well as web content program 300, which has been discussed previously and will be presented in more detail with regard to FIG. 3.

Browser 260 is an application configured for a mobile computing device, such as mobile computing device 210, and enables the mobile computing device to access websites, content, and other resources accessible on the World Wide Web, via the Internet. Browser 260 displays accessed and/or received content on a display screen of the mobile computing device.

Container 240, in some embodiments of the present invention, is a programmed-based storage structure within mobile computing device 210. Container 240 is associated with a particular website that is operated/supported by a web application, for example, web application 160 (FIG. 1). The website to which container 240 is associated is determined by configuration 250, which includes information particular to the identification and access of the website, such as a URL. If there is a second website supported by a second web application, other than web application 160 (FIG. 1), and which includes JSPs, mobile computing device 210 can access and load web pages from the second website by invoking a second instance of web content program 300 that is configured with the particular URL of the second website, and associated with a particular second container which is configured to store static resources downloaded from the second website. In some embodiments of the present invention, configuration 250 may be an entry in a settings field of a container, such as container 240, which identifies and locates the second website as the source of static resources to be stored in container 240. In other embodiments, web content program 300 includes configuration settings that direct access and download activities to a particular website by specifying the URL of the website, and storage of downloaded static resources to a website-specific container, such as container 240.

FIG. 3 illustrates operational steps of web content program 300, inserted on mobile computing device 110 within the distributed data processing environment of FIG. 1, in accordance with an embodiment of the present invention. In step 310 web content program 300 is initiated on a mobile computing device, and accesses a web page from a website supported by a web application that includes JSPs, such as web application 160. For example web content program 300 is an application (app) that is initiated by a user of mobile computing device 110 (FIG. 1), and accesses web application 160, which supports a website that includes JSPs.

In step 320, web content program 300 crawls and analyzes the web page accessed from the website. Web content program 300 identifies the dynamic content and static resources that are included within the web page. Content types may be determined by file type name or label, or by including a configurable feature to select or identify dynamic content types. For example, web content program 300 crawls the web page from the website of web application 160 and analyzes the coding of the web page, and determines dynamic content portions of the web page and references to static resources to include in the web page. The analysis of the dynamic content portions, which are generated by the hosting server, and the references to the static content, may include identifying the “type” of file, object, code, or content included in the coding of the web page.

In step 330 web content program 300 determines the static resources of the web page. The information obtained from crawling and analyzing the web page is used to determine the static resources used in generating the web page. In some embodiments of the present invention, static resources may be determined by the file type or object type designation, or by particular HTML coding within the web page. Static resources may include, but are not limited to the cascading style sheets (CSS) used in the formatting of the web page, images included in the web page, and HTML text content used to produce the web page.

In decision step 340, web content program 300 determines if the static resources are previously stored on the mobile device. Web content program 300 determines dynamic content portions and references to static resource portions of the web page accessed from a website, and searches and compares the static resource referenced in the web page to the previously stored static resources in the container of the mobile computing device. For example, web content program 300 determines that the web page that has been accessed from the website of web application 160 includes a first image as a static resource. Web content program 300 searches container 120 (FIG. 1) of mobile computing device 110, comparing the first image discovered by crawling the web page to static resources previously stored in container 120, to determine if there is a match.

For the case in which web content program 300 determines that the static resources of the web page are not previously stored on the mobile computing device (step 340, “NO” branch), web content program 300, in step 360, downloads the static resource(s) of the web page that is accessed, which are not stored on the mobile computing device. Web content program 300 downloads the static resources identified in the web page, and not previously stored on the mobile computing device, to the container configured to correspond to the website of the accessed web application. For example, having identified a first image and a particular CSS as a first static resource and a second static resource, respectively, of the web page accessed by web content program 300 by using the URL for the website, web content program 300 searches container 120, which is configured to correspond to the website of the web page that is accessed, to determine if container 120 includes previously stored static resources matching the first static resource (image), and the second static resource (a particular CSS). Web content program 300 determines that the particular CSS has been previously downloaded and is stored in container 120; however, the first image has not been previously downloaded and is not stored in container 120. Web content program 300 responds by downloading the first image and storing the first image in container 120 of mobile computing device 110.

For the case in which web content program 300 determines that the static resources are stored on the mobile computing device (step 340, “YES” branch), web content program 300, in decision step 350, determines whether there are updates that have been made to the static resources of the web page. Web content program 300 compares attributes of the static resources determined by crawling the web page, to the attributes of the static resources stored in the container on the mobile computing device for the particular website. A static resource may have an attribute of a creation timestamp, or an expiration timestamp, from which a comparison of versions can be made. Other options to determine whether a static resource has been updated may include requesting the server hosting the resource for the most recent modification timestamp of the resource, and comparing the modification timestamp to that of the resource copy stored in the container. For example, web content program 300 compares a static resource, which may be an HTML text file, identified by crawling the web page from the website that is accessed, to a previously stored version of the static resource in container 120, and determines that the stored HTML text file has an older “modified date” than that of the static resource identified by crawling the web page (the HTML text file has been updated). Browsers often perform caching of static resources; however, browsers will not cache a static resource that is referenced from a dynamic resource, such as from a JSP page.

For the case in which web content program 300 determines that updates have been made to the static resources included in the accessed web page (step 350, “YES” branch), web content program 300 proceeds to step 360 and downloads the updated versions of the static resources and stores the updated static resources in the container corresponding to the website from which the web page was accessed. For example, having determined that updates have been made to an HTML text file that is a static resource of the web page, and is stored in container 120 on mobile computing device 110, web content program 300 downloads the more current version of the HTML text file from web server 140 and stores the updated HTML text file as the static resource (replacing the previous version of the HTML text file) in container 120, which is configured to correspond to the website of web application 160, from which the web page is accessed. In some embodiments of the present invention, web content program 300 may delete the replaced static resource (older version of the HTML text file) from container 120, after downloading and saving the updated version of the static resource.

For the case in which web content program 300 determines that no updates have been made to the static resources of the accessed web page (step 350, “NO” branch), as compared to the static resources stored in the container of the mobile computing device, web content program 300 proceeds to step 370, and directs the building of the web page to use the static resources stored in the container of the mobile computing device. For example, having determined that no updates have been made to static resources of the web page that are stored in container 120, web content program 300 directs the use of the static resources stored in container 120 to build the web page, and suppresses the retrieval of static resources stored on or accessible to web server 140, which is remotely located.

In step 370, web content program 300 directs the build of the web page to use static resources stored on the mobile computing device. Web content program 300 intervenes with the build of the web page and directs web page to include the static resources stored in the container local to the mobile computing device, and not retrieve the static resources from the web server hosting the web application of the website. Embodiments of the present invention require no pre-processing of the content of the website and web content program 300 determines static resources of web pages “on the fly” as a web page is accessed. Additionally web content program 300 only stores the static resources to container 120 that are referenced by the content of the web pages requested from the website of web application 160, by the mobile computing device. Because the access of the web page is through an application, other features of mobile computing device 110 are available to the user, while operating web content program 300.

For example, web content program 300 intervenes with the build of the web page to direct the static resources stored in container 120 of mobile computing device 110 to be used to build the requested web page from the website supported by web application 160. The web page is built using the static resources stored in container 120, and the web page is displayed on mobile computing device 110.

FIG. 4 depicts a block diagram of components of computing system 400, which includes computing device 405. Computing device 405 includes components and functional capability similar to mobile computing device 110 (FIG. 1), web server 140, and mobile computing device 210 (FIG. 2), in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

Computing device 405 includes communications fabric 402, which provides communications between computer processor(s) 404, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406, cache memory 416, and persistent storage 408 are computer readable storage media. In this embodiment, memory 406 includes random access memory (RAM) 414. In general, memory 406 can include any suitable volatile or non-volatile computer readable storage media.

Web content program 300 is stored in persistent storage 408 for execution by one or more of the respective computer processors 404 via one or more memories of memory 406. In this embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of persistent storage 408.

Communications unit 410, in these examples, provides for communications with other data processing systems or devices, including resources of distributed data processing environment 100, web server 140, and mobile computing device 110. In these examples, communications unit 410 includes one or more network interface cards. Communications unit 410 may provide communications through the use of either or both physical and wireless communications links. Web content program 300 may be downloaded to persistent storage 408 through communications unit 410.

I/O interface(s) 412 allows for input and output of data with other devices that may be connected to computing system 400. For example, I/O interface 412 may provide a connection to external devices 418 such as a keyboard, keypad, a touch screen, and/or some other suitable input device. External devices 418 can also include portable computer readable storage media such as, for example, thumb drives, portable optical or magnetic disks, and memory cards. Software and data used to practice embodiments of the present invention, e.g., web content program 300 can be stored on such portable computer readable storage media and can be loaded onto persistent storage 408 via I/O interface(s) 412. I/O interface(s) 412 also connect to a display 420.

Display 420 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for displaying web content on a mobile computing device, the method comprising:
requesting, by one or more processors, web content from a website, based on a uniform resource locator, wherein the uniform resource locator corresponds to the website;
receiving, by one or more processors, the web content generated by the website, which includes a dynamic content portion that is generated, and one or more references to one or more static resources, respectively, wherein the one or more static resources are static content;
determining, by one or more processors, the one or more static resources referenced in the web content that is requested;
determining, by one or more processors, whether one or more, of the one or more static resources referenced in the web content are stored within the mobile computing device;
responsive to determining that a first static resource of the one or more static resources referenced in the web content is not stored within the mobile computing device, retrieving, by one or more processors, the first static resource of the one or more static resources referenced in the web content, and storing the first static resource within the mobile computing device; and
building, by one or more processors, the web content on the mobile computing device, including the first static resource referenced in the web content, wherein the first static resource is obtained from one or more static resources stored on the mobile computing device.

2. The method of claim 1, wherein the web content of the website is a web page that is dynamically generated by a Web 1.0 application on a web application server.

3. The method of claim 1, wherein retrieving the one or more static resources that are referenced in the web content that is requested from the website, includes the one or more static resources that are not previously stored within the mobile computing device, and excludes retrieving one or more static resources that are referenced in web content that is not requested from the website.

4. The method of claim 1, wherein the one or more static resources that are static content and are included in the web content that is requested from the website, are stored within the mobile computing device such that a set of the one or more static resources are associated with the web content of the website by a configuration setting.

5. The method of claim 1, wherein storing the first static resource within the mobile computing device, further comprises:
storing, by one or more processors, the first static resource in a container within the mobile computing device, wherein the container is a structure for storing static resources, and the container is particular to the website from which the web content is requested.

6. The method of claim 1, further comprising:
responsive to determining a second static resource of the one or more static resources is stored in the mobile computing device, determining, by one or more processors, whether the second static resource referenced in the web content is updated as compared to the static content stored in the mobile computing device; and
responsive to determining the second static resource referenced in the web content is updated as compared to the static content stored in the mobile computing device, retrieving, by one or more processors, the second static resource referenced in the web content that is updated, and replacing the static content stored in the mobile computing device.

7. The method of claim 1, further comprising:
responsive to determining that a first static resource of the one or more static resources referenced in the web content is stored within the mobile computing device, retrieving, by one or more processors, the first static resource that is stored in the mobile computing device and including the first static resource in the display of the web content on the mobile computing device.

8. A computer program product for displaying web content on a mobile computing device, the computer program product comprising:
one or more computer readable storage media wherein the computer readable storage medium is not a transitory signal per se, and program instructions stored on the one or more computer readable storage media, the program instructions comprising:
program instructions to request web content from a website, based on a uniform resource locator, wherein the uniform resource locator corresponds to the website;
program instructions to receive the web content generated by the website, which includes a dynamic content portion that is generated, and one or more references to one or more static resources, respectively, wherein the one or more static resources are static content;
program instructions to determine the one or more static resources referenced in the web content that is requested;
program instructions to determine whether one or more of the one or more static resources referenced in the web content are stored within the mobile computing device;
responsive to determining that a first static resource of the one or more static resources referenced in the web content is not stored within the mobile computing device, program instructions to retrieve the first static resource of the one or more static resources referenced in the web content, and store the first static resource within the mobile computing device; and
program instructions to build the web content on the mobile computing device, including the first static resource referenced in the web content, wherein the first static resource is obtained from one or more static resources stored on the mobile computing device.

9. The computer program product of claim 8, wherein the web content of the website is a web page that is dynamically generated by a Web 1.0 application on a web application server.

10. The computer program product of claim 8, wherein retrieving the one or more static resources that are referenced in the web content that is requested from the website, includes the one or more static resources that are not previously stored within the mobile computing device, and excludes retrieving one or more static resources that are referenced in web content that is not requested from the website.

11. The computer program product of claim 8, wherein the one or more static resources that are static content and are included in the web content that is requested from the website, are stored within the mobile computing device such that a set of the one or more static resources are associated with the web content of the website by a configuration setting.

12. The computer program product of claim 8, wherein storing the first static resource within the mobile computing device, further comprises:
program instructions to store the first static resource in a container within the mobile computing device, wherein the container is a structure for storing static resources, and the container is particular to the website from which the web content is requested.

13. The computer program product of claim 8, further comprising:
responsive to determining a second static resource of the one or more static resources is stored in the mobile computing device, program instructions to determine whether the second static resource referenced in the web content is updated as compared to the static content stored in the mobile computing device; and
responsive to determining the second static resource referenced in the web content is updated as compared to the static content stored in the mobile computing device, program instructions to retrieve the second static resource referenced in the web content that is updated, and replacing the static content stored in the mobile computing device.

14. The computer program product of claim 8, further comprising:
responsive to determining that a first static resource of the one or more static resources referenced in the web content is stored within the mobile computing device, program instructions to retrieve the first static resource that is stored in the mobile computing device and program instructions to include the first static resource in the display of the web content on the mobile computing device.

15. A computer system for displaying web content on a mobile computing device, the computer program product comprising:
one or more computer processors, one or more computer readable storage media, program instructions stored on the computer readable storage media for execution by at least one of the one or more processors, the program instructions comprising:
program instructions to request web content from a website, based on a uniform resource locator, wherein the uniform resource locator corresponds to the website;
program instructions to receive the web content generated by the website, which includes a dynamic content portion that is generated, and one or more references to one or more static resources, respectively, wherein the one or more static resources are static content;
program instructions to determine the one or more static resources referenced in the web content that is requested;
program instructions to determine whether one or more of the one or more static resources referenced in the web content are stored within the mobile computing device;
responsive to determining that a first static resource of the one or more static resources referenced in the web content is not stored within the mobile computing device, program instructions to retrieve the first static resource of the one or more static resources referenced in the web content, and store the first static resource within the mobile computing device; and
program instructions to build the web content on the mobile computing device, including the first static resource referenced in the web content, wherein the first static resource is obtained from one or more static resources stored on the mobile computing device.

16. The computer system of claim 15, wherein the web content of the website is a web page that is dynamically generated by a Web 1.0 application on a web application server.

17. The computer system of claim 15, wherein retrieving the one or more static resources that are static content referenced in the web content that is requested from the website, includes the one or more static resources that are not previously stored within the mobile computing device, and excludes retrieving one or more static resources that are referenced in web content that is not requested from the website.

18. The computer system of claim 15, wherein storing the first static resource within the mobile computing device, further comprises:
program instructions to store the first static resource in a container within the mobile computing device, wherein the container is a structure for storing static resources, and the container is particular to the website from which the web content is requested.

19. The computer system of claim 15, further comprising:
responsive to determining a second static resource of the one or more static resources is stored in the mobile computing device, program instructions to determine whether the second static resource referenced in the web content is updated as compared to the static content stored in the mobile computing device; and
responsive to determining the second static resource referenced in the web content is updated as compared to the static content stored in the mobile computing device, program instructions to retrieve the second static resource referenced in the web content that is updated, and replacing the static content stored in the mobile computing device.

20. The computer system of claim 15, further comprising:
responsive to determining that a first static resource of the one or more static resources referenced in the web content is stored within the mobile computing device, program instructions to retrieve the first static resource that is stored in the mobile computing device and program instructions to include the first static resource in the display of the web content on the mobile computing device.
